(19) United States
(12) Patent Application Publication
(10) Pub. No.: US 2014/0191979 A1
(43) Pub. Date: Jul. 10, 2014

(54) Operating System Signals to Applications Responsive to Double-Tapping

(71) Applicant: APPLE INC., Cupertino, CA (US)

(72) Inventor: Maxim Tsudik, Herzeliya (IL)

(73) Assignee: Apple Inc., Cupertino, CA (US)

(21) Appl. No.: 13/738,984

(22) Filed: Jan. 10, 2013

(51) Int. Cl. G06F 3/01

(52) U.S. Cl. CPC G06F 3/01
USPC 345/173

(57) ABSTRACT

A mobile device can execute an operating system that presents icons on a touchscreen. The mobile device can detect a single-tap or a double-tap made by the user relative to an icon. In response to a single-tap relative to an icon, the operating system can send a first type of signal to an application. In response to a double-tap relative to the icon, the operating system can send a second type of signal to the application. The application can react to the receipt of the first type of signal in a manner that is different from the manner in which the application reacts to the receipt of the second type of signal. In response to first type of signal, the application can present an item list. In response to the second type of signal, the application can enable new item creation.

### BACKGROUND

The present disclosure relates generally to mobile devices, and in particular to techniques for manipulating mobile device user interfaces based on user interactions with those mobile devices.

A mobile device (also known as a handheld device, handheld computer, or simply handheld) can be a small, hand-held computing device, typically having a display screen with touch input and/or a miniature keyboard. A handheld computing device has an operating system (OS), and can run various types of application software, sometimes called “apps.” Most handheld devices can also be equipped with Wi-Fi, Bluetooth, and global positioning system (GPS) capabilities. Wi-Fi components can allow wireless connections to the Internet. Bluetooth components can allow wireless connections to other Bluetooth capable devices such as an automobile or a microphone headset. A camera or media player feature for video or music files can also be typically found on these devices along with a stable battery power source such as a lithium battery. Mobile devices often come equipped with a touchscreen interface that acts as both an input and an output device.

Mobile phones are a kind of mobile device. A mobile phone (also known as a cellular phone, cell phone, or hand phone) is a device that can make and receive telephone calls over a radio link while moving around a wide geographic area. A mobile phone can do so by connecting to a cellular network provided by a mobile phone operator, allowing access to the public telephone network. In addition to telephony, modern mobile phones can often also support a wide variety of other services such as text messaging, multimedia messaging service (MMS), e-mail, Internet access, short-range wireless communications (infrared, Bluetooth, etc.), business applications, gaming, and photography. Mobile phones that offer these and more general computing capabilities are often referred to as smart phones.

The Apple iPhone, in its various generations, is a smart phone. The iPhone includes a variety of components, such as a GPS, an accelerometer, a compass, and a gyroscope, which the iPhone's OS can use to determine the iPhone's current location, orientation, speed, and attitude. The iPhone's OS can detect events from these components and pass these events on to applications that are executing on the iPhone. Those applications can then handle the events in a manner that is custom to those applications. For example, using its built-in components, the iPhone can detect when it is being shaken, and can pass an event representing the shaking on to applications that have registered to listen for such an event. An application can respond to that event, for example, by changing the images that the iPhone is currently presenting on its touchscreen display.

Like many mobile devices, the iPhone, and its cousins the iPad and iPod Touch, come equipped with a touchscreen interface that can detect physical contact from a user of the mobile device and generate a corresponding event. For example, the iPhone can detect when a user has single-tapped the screen, double-tapped the screen, made a pinching motion relative to the screen, made a swiping motion across the screen, or made a flicking motion on the screen with his fingertips. Each such user interaction relative to the iPhone can cause a different kind of corresponding event to be generated for consumption by interested applications. Thus, the iPhone, iPad, and iPod Touch are able to detect and respond to a variety of physical interactions that a user can take relative those devices.

A mobile device's touchscreen is usually the primary mechanism by which the mobile device's user interacts with user interface elements (e.g., icons) that are displayed on the touchscreen. Thus, if a user desires to launch an application, the user might tap on the application's icon shown on the mobile device's display. Alternatively, if a user desires to move an icon from one location to another in the user interface, the user might press down on that icon's location on the display and then slide his fingertip across the touchscreen to the destination at which the user wants the icon to be placed. A user of a more conventional computer, such as a desktop computer, would likely use a separate pointing device such as a mouse to perform similar operations.

### BRIEF DESCRIPTION

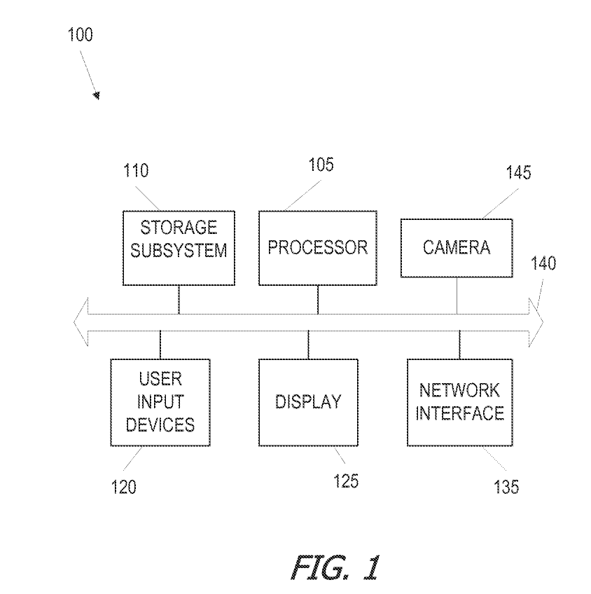

FIG. 1 is a block diagram of a computer system according to an embodiment of the present invention.

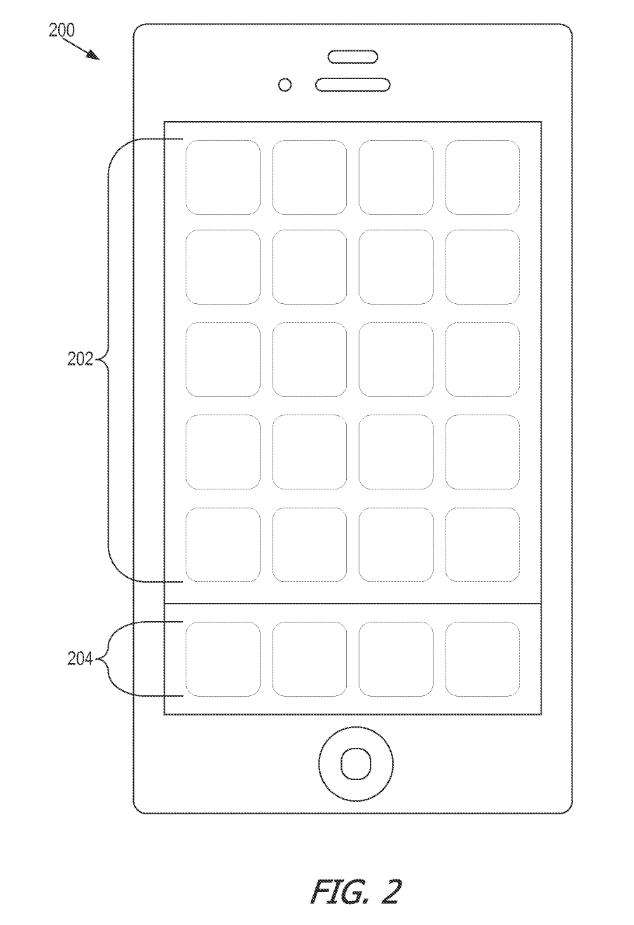

FIG. 2 is a block diagram illustrating an example of a mobile device that can display an operating system user interface that reacts differently to single-taps and double-taps, according to an embodiment of the invention.

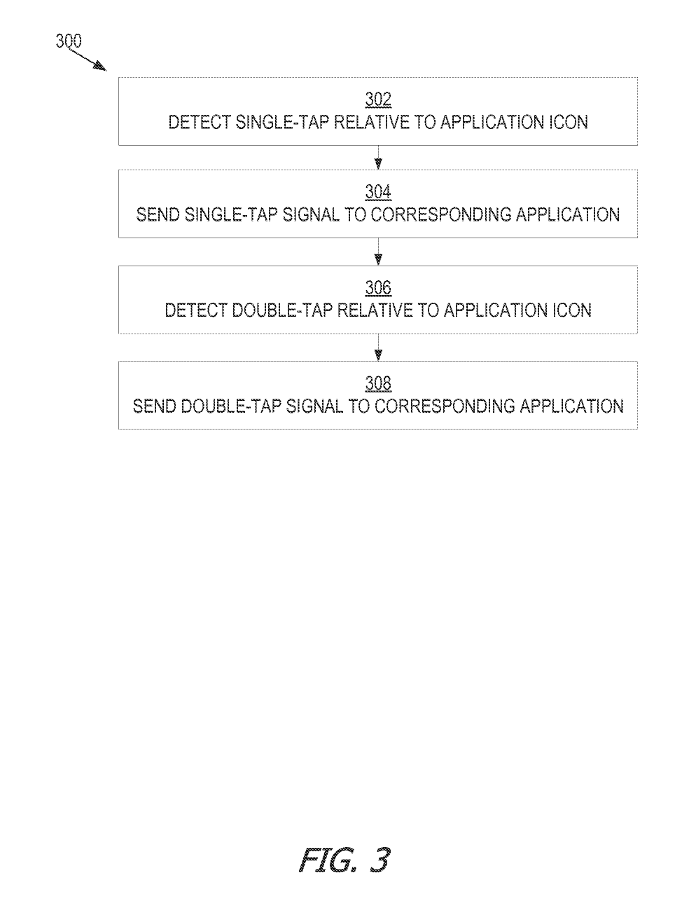

FIG. 3 is a flow diagram illustrating an example of a technique whereby an operating system of a mobile device can send, to an application on whose icon a user has single-tapped or double-tapped, a signal whose type depends on whether the tap is a single-tap or a double-tap, according to an embodiment of the invention.

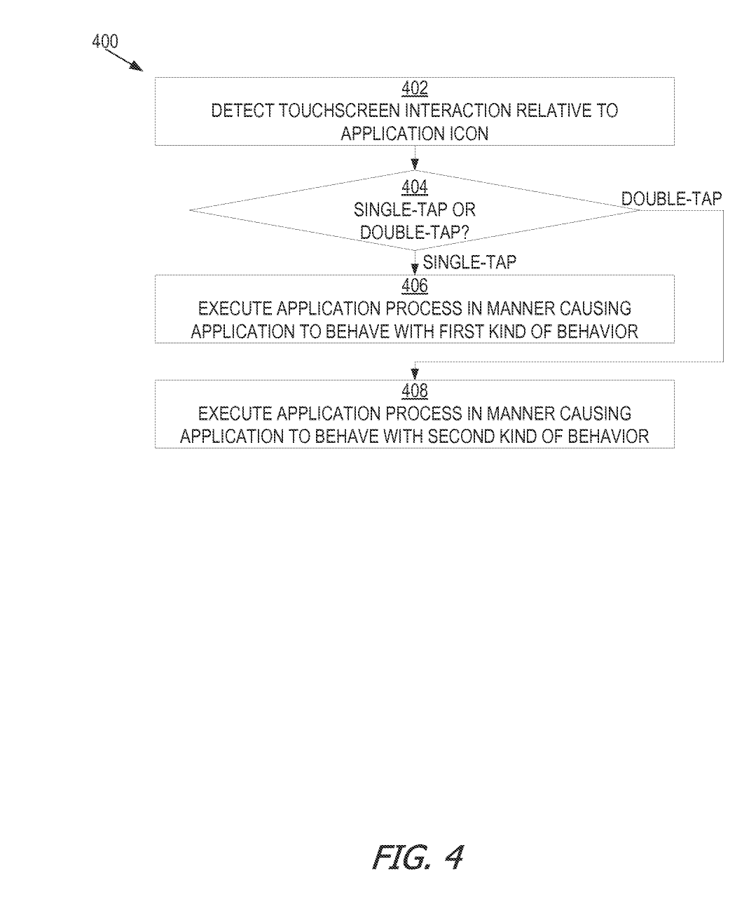

FIG. 4 is a flow diagram illustrating an example of a technique whereby an operating system of a mobile device can execute an application process in a manner that causes the application process to perform a behavior that depends on whether the operating system detected a single-tap or a double-tap relative to an icon to which the application pertains, according to an embodiment of the invention.

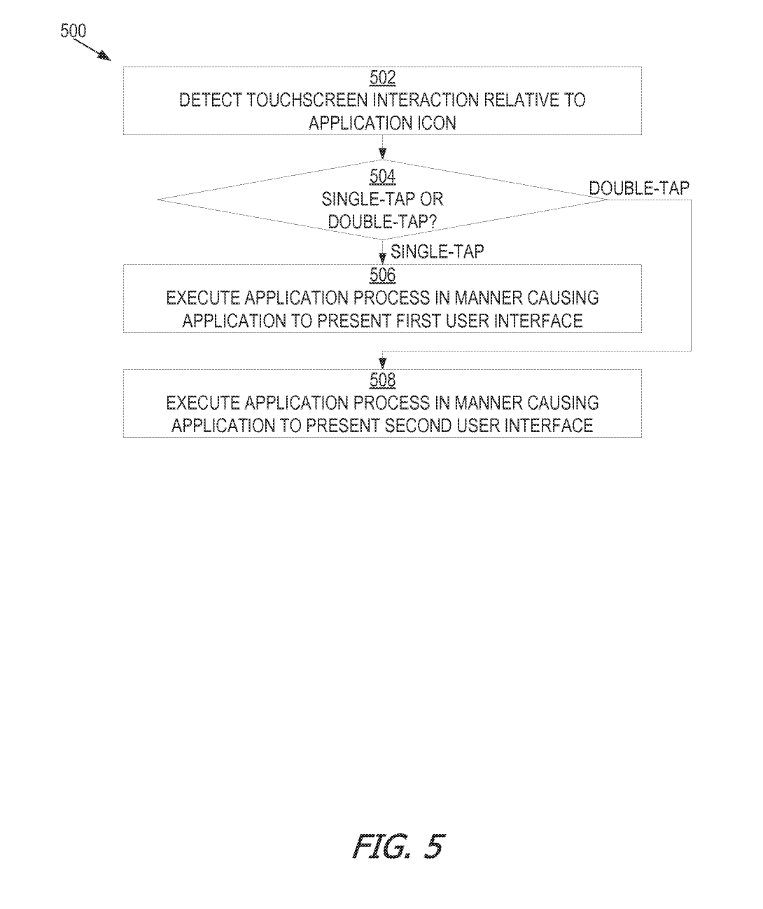

FIG. 5 is a flow diagram illustrating an example of a technique whereby an operating system of a mobile device can execute an application process in a manner that causes the application process to select, for presentation, a particular user interface from a group of multiple user interfaces based on whether the operating system detected a single-tap or a double-tap relative to an icon to which the application pertains, according to an embodiment of the invention.

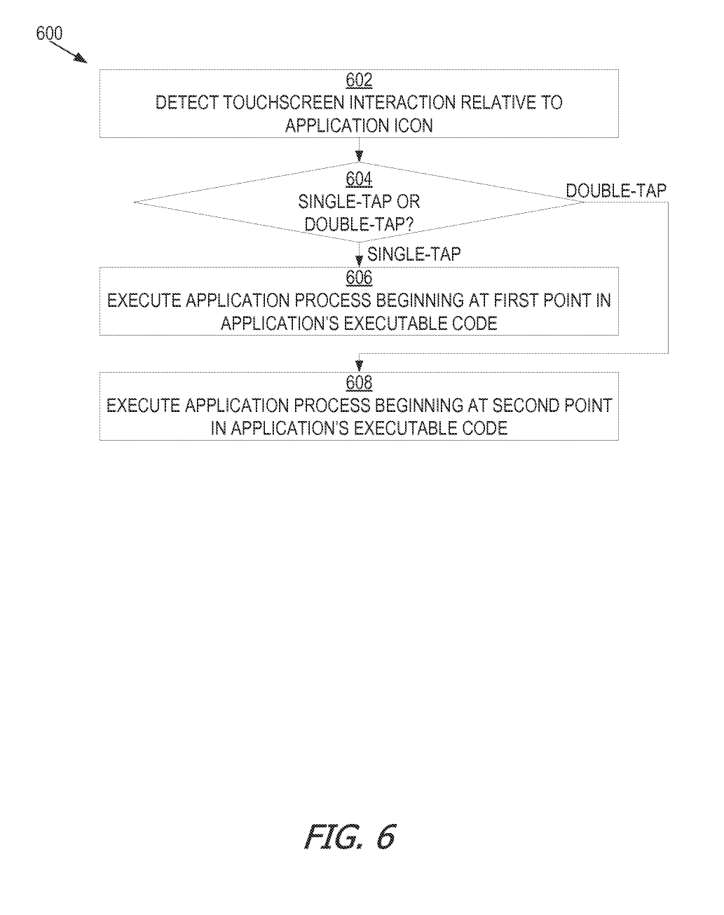

FIG. 6 is a flow diagram illustrating an example of a technique whereby an operating system of a mobile device can execute an application process in a manner that causes the application process to begin executing at a point in its code that is selected based on whether the operating system detected a single-tap or a double-tap relative to an icon to which the application pertains, according to an embodiment of the invention.

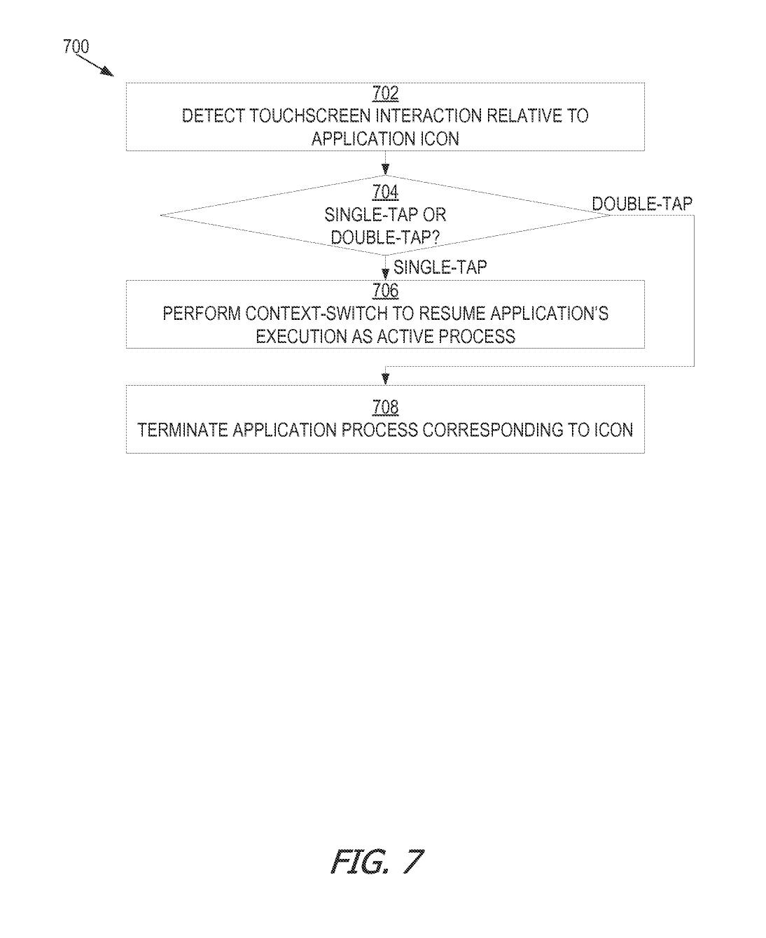

FIG. 7 is a flow diagram illustrating an example of a technique whereby an operating system of a mobile device can either context-switch to an application process or terminate that application process depending on whether the operating system detected a single-tap or a double-tap relative to an icon to which the application process pertains, according to an embodiment of the invention.

### DETAILED DESCRIPTION

Embodiments of the invention can involve a mobile device that includes a touchscreen display through which a user can single-tap or double-tap on displayed graphical elements in order to interact with software executing on the mobile device. More specifically, in an embodiment of the invention, the mobile device can execute an operating system that presents, via the touchscreen display, a group of icons that correspond to application programs that are stored in the persistent memory of the mobile device. Each such icon may represent a separate application program. The mobile device can detect a single-tap or a double-tap made by the user—such as by the user's fingertips contacting the touchscreen display—relative to any particular icon. In response to detecting a single-tap relative to the particular icon, the operating system can send a first type of signal to the application program to which the particular icon corresponds. Contrastingly, in response to detecting a double-tap relative to the particular icon, the operating system can send a second type of signal to the application program to which the particular icon corresponds. Such signals can be sent through the invocation of a method that is defined by an application programming interface (API). In one embodiment, the API is implemented by the operating system.

In an embodiment of the invention, the first type of signal can be different from the second type of signal. The application program can react to the receipt of the first type of signal in a manner that is different from the manner in which the application program reacts to the receipt of the second type of signal. For example, in response to the receipt of the first type of signal, the application program can start up and present one kind of user interface, but in response to the second type of signal, the application program can start up and present a second kind of user interface that differs in content or appearance from the first kind of user interface. Thus, in response to detecting a single-tap, the operating system can cause the application program to behave one way, and in response to detecting a double-tap, the operating system can cause the application program to behave in another way.

In an embodiment of the invention, the type of behaviors that single-taps and double-taps cause an application to perform can vary depending on the application. In one embodiment, a single-tap will cause an application to launch and present previously stored content, but a double-tap will cause that application to launch and present a user interface through which a user can create and store new content. For example, in response to a single-tap, a notes application can load and display the last screen that the notes application previously displayed; but in response to a double-tap, that notes application can open and present a new (i.e., blank) note user interface, thereby sparing the user an extra tap on a user interface control to open a new note. For another example, in response to a single-tap, a mail application can load and open a list of e-mail messages in an in-box; but in response to a double-tap, that mail application can open and present a user interface through which a user can compose a new e-mail message to be sent. For another example, in response to a single-tap, a reminders application can load and present list of reminders; but in response to a double-tap, that reminders application can open and present a user interface through which a user can create a new reminder to be added to the list. For another example, in response to a single-tap, a calendar application can load and present an overview of a calendar (e.g., for a month); but in response to a double-tap, that calendar application can open and present a user interface through which a user can create a new event to be placed on the calendar. For another example, in response to a single-tap, a contacts application can load and present list of contacts (i.e., information about people and ways to communicate with those people); but in response to a double-tap, that contacts application can open and present a user interface through which a user can create a new contact to be added to the list. For yet another example, in response to a single-tap, a voice memos application can load and present list of voice memos; but in response to a double-tap, that contacts application can open and present a user interface through which a user can create and record a new voice memo to be added to the list.

The following detailed description together with the accompanying drawings will provide a better understanding of the nature and advantages of the present invention.

FIG. 1 illustrates a computing system 100 according to an embodiment of the present invention. Computing system 100 can be implemented as any of various computing devices, including, e.g., a desktop or laptop computer, tablet computer, smart phone, personal data assistant (PDA), or any other type of computing device, not limited to any particular form factor. Computing system 100 can include processing unit(s) 105, storage subsystem 110, input devices 120, display 125, network interface 135, and bus 140. Computing system 100 can be an iPhone or an iPad.

Processing unit(s) 105 can include a single processor, which can have one or more cores, or multiple processors. In some embodiments, processing unit(s) 105 can include a general-purpose primary processor as well as one or more special-purpose co-processors such as graphics processors, digital signal processors, or the like. In some embodiments, some or all processing units 105 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 105 can execute instructions stored in storage subsystem 110.

Storage subsystem 110 can include various memory units such as a system memory, a read-only memory (ROM), and a permanent storage device. The ROM can store static data and instructions that are needed by processing unit(s) 105 and other modules of computing system 100. The permanent storage device can be a read-and-write memory device. This permanent storage device can be a non-volatile memory unit that stores instructions and data even when computing system 100 is powered down. Some embodiments of the invention can use a mass-storage device (such as a magnetic or optical disk or flash memory) as a permanent storage device. Other embodiments can use a removable storage device (e.g., a floppy disk, a flash drive) as a permanent storage device. The system memory can be a read-and-write memory device or a volatile read-and-write memory, such as dynamic random access memory. The system memory can store some or all of the instructions and data that the processor needs at runtime.

Storage subsystem 110 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 110 can include removable storage media that can be readable and/or writeable; examples of such media include compact disc (CD), read-only digital versatile disc (e.g., DVD-ROM, dual-layer DVD-ROM), read-only and recordable Blu-Ray® disks, ultra density optical disks, flash memory cards (e.g., SD cards, mini-SD cards, micro-SD cards, etc.), magnetic “floppy” disks, and so on. The computer readable storage media do not include carrier waves and transitory electronic signals passing wirelessly or over wired connections.

In some embodiments, storage subsystem 110 can store one or more software programs to be executed by processing unit(s) 105. “Software” refers generally to sequences of instructions that, when executed by processing unit(s) 105 cause computing system 100 to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 110, processing unit(s) 105 can retrieves program instructions to execute and data to process in order to execute various operations described herein.

A user interface can be provided by one or more user input devices 120, display device 125, and/or and one or more other user output devices (not shown). Input devices 120 can include any device via which a user can provide signals to computing system 100; computing system 100 can interpret the signals as indicative of particular user requests or information. In various embodiments, input devices 120 can include any or all of a keyboard, touch pad, touch screen, mouse or other pointing device, scroll wheel, click wheel, dial, button, switch, keypad, microphone, and so on.

Display 125 can display images generated by computing system 100 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). Some embodiments can include a device such as a touchscreen that function as both input and output device. In some embodiments, other user output devices can be provided in addition to or instead of display 125. Examples include indicator lights, speakers, tactile “display” devices, printers, and so on.

In some embodiments, the user interface can provide a graphical user interface, in which visible image elements in certain areas of display 125 are defined as active elements or control elements that the user can select using user input devices 120. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular array in display 125. Other user interfaces can also be implemented.

Network interface 135 can provide voice and/or data communication capability for computing system 100. In some embodiments, network interface 135 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments, network interface 135 can provide wired network connectivity (e.g., Ethernet) in addition to or instead of a wireless interface. Network interface 135 can be implemented using a combination of hardware (e.g., antennas, modulators/demodulators, encoders/decoders, and other analog and/or digital signal processing circuits) and software components.

Bus 140 can include various system, peripheral, and chipset buses that communicatively connect the numerous internal devices of computing system 100. For example, bus 140 can communicatively couple processing unit(s) 105 with storage subsystem 110. Bus 140 also connects to input devices 120 and display 125. Bus 140 also couples computing system 100 to a network through network interface 135. In this manner, computing system 100 can be a part of a network of multiple computer systems (e.g., a local area network (LAN), a wide area network (WAN), an Intranet, or a network of networks, such as the Internet. Any or all components of computing system 100 can be used in conjunction with the invention.

A camera 145 also can be coupled to bus 140. Camera 145 can be mounted on a side of computing system 100 that is on the opposite side of the mobile device as display 125. Camera 145 can be mounted on the “back” of such computing system 100. Thus, camera 145 can face in the opposite direction from display 125.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing unit(s) 105 can provide various functionality for computing system 100. For example, processing unit(s) 105 can execute a tap-detecting operating system. In some embodiments, the tap-detecting operating system is a software-based process that can determine whether any surface of computing system 100 has been tapped, and can perform responsive actions, such as the manipulation of user interface elements shown on display 125, in response.

It will be appreciated that computing system 100 is illustrative and that variations and modifications are possible. Computing system 100 can have other capabilities not specifically described here (e.g., mobile phone, global positioning system (GPS), power management, one or more cameras, various connection ports for connecting external devices or accessories, etc.). Further, while computing system 100 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

According to an embodiment of the invention, an operating system can detect contacts, such as fingertip contacts, against a touchscreen display of a mobile device on which the operating system executes. An operating system is a software program that provides functionality through which a user can access other programs, called application programs, which are stored within the persistent memory of the mobile device. The operating system can provide methods that such application programs can invoke in order to interact with the physical hardware components of the device, such as the touchscreen display, speakers, earphones, a microphone, a gyroscope, an accelerometer, a global positioning system (GPS), a wireless network interface, volume up and down buttons, a ringer silencing switch, a “home” button, a video camera, a flash bulb, a clock, and/or the persistent storage of the mobile device (e.g., flash memory, hard disk drive, etc.). In response to detecting an interaction or a change in state relative to such a component, the operating system can automatically generate an event that specifies the type of interaction or change and the hardware component relative to which the interaction or change occurred. Application programs can register with the operating system to listen for particular types of events, such as events that occur relative to a specified hardware component, and/or events of specified types. After an application program registers for a particular type of event, the operating system can automatically notify that application program whenever that particular type of event occurs. Multiple application programs can register for the same type of event, and a particular application program can register for multiple different types of events.

Among the different types of events that the operating system can generate in response to user interaction with the mobile device's touchscreen are single-tap events and double-tap events. Single-tap events and double-tap events generally both can involve some quantity of taps. In an embodiment of the invention, the operating system can distinguish between a tap and another type of touchscreen contact based on the duration of time for which the contact endures. In an embodiment, the operating system deems all touchscreen contacts that last less than a threshold amount of time to be taps, and the operating system deems all other longer-lasting touchscreen contacts to be non-tap contacts. Additionally, in an embodiment of the invention, the operating system can distinguish between a sequence of multiple single-taps and a single double-tap. In an embodiment, after detecting a tap, the operating system can begin a timer that the operating system stops in response to detecting a subsequent tap. If the value of the timer is less than a specified threshold at the time that the operating system stops the timer in this manner, then the operating system can deem the earlier tap and the later tap to be, together, a double-tap. Conversely, if the value of the timer is not less than this specified threshold at the time that the operating system stops the timer in this manner, then the operating system can deem the earlier tap and the later tap to be separate single-taps. The type of event that the operating system generates in response to detecting a single-tap can be different from the type of event that the operating system generates in response to detecting a double-tap event. Application program can register to listen for single-tap events or double-tap events, or for both types of events. Application programs can respond to the occurrence of these different types of events in different customized manners.

In an embodiment of the invention, an application programming interface (API) can defined. The API is a standard to which different programs can conform. In an embodiment, the API defines various different methods that the operating system can automatically invoke in response to the occurrence of different events. Each such method can have a method interface that specifies an associated event type, an associated name, an associated set of input parameters, and potentially an associated return data type. For example, the single-tap event type can be associated with a single-tap method interface, while the double-tap event type can be associated with a double-tap method interface. The names and input parameters of the single-tap method interface can different from those of the double-tap method interface. In an embodiment of the invention, each program that is designed to respond to a single-tap event implements, in its custom code, a method having the single-tap method interface defined by the API. Similarly, in an embodiment of the invention, each program that is designed to respond to a double-tap event implements, in its custom code, a method having the double-tap method interface defined by the API.

In an embodiment of the invention, the operating system can cause the mobile device to display an operating system user interface. This operating system user interface can include a visual representation of the application programs that are accessible through the operating system. Each such application program can have an associated graphical icon that distinctively identifies that application program and distinguishes it from other application programs. The operating system user interface can present, on the mobile device's touchscreen display, a group of some or all of the icons of the application programs that are accessible through the operating system. The operating system can detect single-taps and double-taps made at various positions on the touchscreen, and can determine the position at which those single-taps or double-taps were made. The operating system can determine, based on the position, to which of the several displayed application icons the single-tap or double-tap was directed. In an embodiment, in response to detecting a single-tap relative to a particular application icon, the operating system can send a single-tap type of signal to the application program associated with that particular icon, potentially by automatically invoking the single-tap method implemented by that application program. Similarly, in an embodiment, in response to detecting a double-tap relative to a particular application icon, the operating system can send a double-tap type of signal to the application program associated with that particular icon, potentially by automatically invoking the double-tap method implemented by that application program.

In an embodiment of the invention, the manner in which the operating system sends a signal to a particular application can vary depending on whether the icon to which the single-tap or double-tap was directed represents a currently executing application process or a currently non-executing application program. In an embodiment, the operating system user interface can present icons for currently executing application processes in an area that is separate and distinct from the area in which the operating system user interface presents icons for current non-executing application programs. For example, the operating system user interface can present icons for currently non-executing application programs in the main area of the touchscreen display, while ordinarily hiding icons for currently executing application processes. In response to detecting user interaction with a physical component of the mobile device, such as the mobile device's “home” button located on the same surface as the touchscreen but below the display, the operating system can cause the operating system user interface to show (or “pop-up”) the ordinarily hidden icons for currently executing application processes in an area that is visually distinguished from the area in which the remainder of the icons are displayed.

In an embodiment, when the operating system detects a single-tap or double-tap relative to an icon for a currently non-executing application program, the operating system can responsively execute that application program (thus creating a corresponding executing application process) and invoke its single-tap or double-tap method, depending on the tap type. Contrastingly, in an embodiment, when the operating system detects a single-tap or double-tap relative to an icon for a currently executing application process, the operating system can responsively invoke its single-tap or double-tap method, depending on the tap type. In one embodiment of the invention, an application can implement a single-tap method to be executed in response to interaction with a currently non-executing application program's icon separately and differently from a single-tap method to be executed in response to interaction with a currently executing application process's icon. Similarly, in one embodiment of the invention, an application can implement a double-tap method to be executed in response to interaction with a currently non-executing application program's icon separately and differently from a double-tap method to be executed in response to interaction with a currently executing application process's icon.

In an embodiment of the invention, in response to receiving a single-tap signal from the operating system as discussed above, an application can behave in a first manner, but in response to receiving a double-tap signal from the operating system as discussed above, the application can behave in a second manner that differs from the first manner. In an embodiment of the invention, in response to receiving a single-tap signal from the operating system as discussed above, an application can present a first user interface via the mobile device's display, but in response to receiving a double-tap signal from the operating system as discussed above, the application can present, via the mobile device's display, a second user interface that differs from the first user interface in appearance and/or content. For example, the first user interface can include a first set of user-selectable menu items, while the second user interface can include a second set of user-selectable menu items that differs from the first set. In an embodiment of the invention, in response to receiving a single-tap signal from the operating system as discussed above, a currently non-executing application program can start execution beginning at a first point in its application code, but in response to receiving a double-tap signal from the operating system as discussed above, the currently non-executing application program can start execution beginning at a second point in its application code that is before or after the first point.

FIG. 2 is a block diagram illustrating an example of a mobile device 200 that can display an operating system user interface that reacts differently to single-taps and double-taps, according to an embodiment of the invention. Mobile device 200 can be a smart phone such as an Apple iPhone, for example. Mobile device 200 can have a display that shows application icons 202 for currently non-executing application programs in a main area of the operating system user interface. On this display, mobile device 200 can additionally show application icons 204 for currently executing application processes in a sub-area of the operating system user interface. By detecting single-taps and double-taps relative to application icons 202, the operating system of mobile device 200 can execute, or launch (i.e., start processes for), corresponding applications that are stored within the persistent memory of mobile device 200, and automatically send single-tap or double-tap signals (depending on the type of tap detected) to those applications. Additionally, by detecting single-taps and double-taps relative to application icons 204, the operating system of mobile device 200 can automatically send, to corresponding application processes, single-tap or double-tap signals (depending on the type of tap detected) to those applications. In one embodiment, a double-tap detected relative to an application icon 204 can cause the operating system to terminate the corresponding application process.

FIG. 3 is a flow diagram illustrating an example of a technique 300 whereby an operating system of a mobile device can send, to an application on whose icon a user has single-tapped or double-tapped, a signal whose type depends on whether the tap is a single-tap or a double-tap, according to an embodiment of the invention. For example, technique 300 can be performed by mobile device 200 of FIG. 2, or, more specifically, by an operating system executing on mobile device 200 in conjunction with hardware components that detect touchscreen contact and send signals to that operating system. Although certain operations are described as being performed in a certain order in technique 300, alternative embodiments of the invention can involve similar techniques being performed with fewer, additional, or different operations, and/or with those operations being performed in a different order.

In block 302, a mobile device can detect a single-tap relative to an application icon displayed on the device's touchscreen. For example, the mobile device can detect that a user's fingertip has made contact with a particular icon's position on the touchscreen, and that the contact has lasted for less than a specified amount of time, and that no subsequent contact was made relative to the same position within a specified interval of time subsequent to the initial contact, thus indicating a single-tap relative to the particular icon.

In block 304, in response to detecting the single-tap in block 302, the mobile device can send a single-tap signal to the application to which the application icon pertains. For example, in response to detecting that a single-tap was made relative to an Internet-browsing application's icon, the mobile device can send a single-tap signal to the Internet-browsing application. The Internet-browsing application can respond to the single-tap signal, for example, by behaving in a first manner.

In block 306, the mobile device can detect a double-tap relative to the same application icon displayed on the device's touchscreen. For example, the mobile device can detect that a user's fingertip has made contact twice with the particular icon's position on the touchscreen, and that the first and second contacts have each lasted for less than a specified amount of time, and that the second contact was made relative to the same position within a specified interval of time subsequent to the first contact, thus indicating a double-tap relative to the particular icon (rather than a sequence of single-taps).

In block 308, in response to detecting the double-tap in block 306, the mobile device can send, to the application to which the application icon pertains, a double-tap signal that differs from the single-tap signal. For example, in response to detecting that a double-tap was made relative to an Internet-browsing application's icon, the mobile device can send a double-tap signal to the Internet-browsing application. The Internet-browsing application can respond to the double-tap signal, for example, by behaving in a second manner that differs from the first manner.

FIG. 4 is a flow diagram illustrating an example of a technique 400 whereby an operating system of a mobile device executes an application process in a manner that causes the application process to perform a behavior that depends on whether the operating system detected a single-tap or a double-tap relative to an icon to which the application pertains, according to an embodiment of the invention. For example, technique 400 can be performed by mobile device 200 of FIG. 2, or, more specifically, by an operating system executing on mobile device 200 in conjunction with hardware components that detect touchscreen contact and send signals to that operating system. Although certain operations are described as being performed in a certain order in technique 400, alternative embodiments of the invention can involve similar techniques being performed with fewer, additional, or different operations, and/or with those operations being performed in a different order.

In block 402, a mobile device can detect touchscreen interaction by a user relative to an application icon displayed on the device's touchscreen. For example, the mobile device can detect that a user has performed a single-tap or a double-tap relative to an icon that pertains to a currently non-executing application program (e.g., an Internet-browsing application program).

In block 404, in response to detecting the touchscreen interaction in block 402, the mobile device can determine whether the interaction was a single-tap or a double-tap. If the interaction was a single-tap, then control passes to block 406. Alternatively, if the interaction was a double-tap, then control passes to block 408.

In block 406, the mobile device can execute an application process for an application corresponding to the icon in a manner that causes the application process to behave initially with a first kind of behavior. For example, in response to determining that the interaction relative to an Internet-browsing application's icon was a single-tap rather than a double-tap, the operating system can start up an Internet-browsing application process in a manner that causes the Internet-browsing application process to request (over the wireless network interface) and present (on the display) a home page whose universal resource locator (URL) is specified in the application's configuration settings.

Alternatively, in block 408, the mobile device can execute an application process for an application corresponding to the icon in a manner that causes the application process to behave initially with a second kind of behavior that differs from the first kind of behavior. For example, in response to determining that the interaction relative to an Internet-browsing application's icon was a double-tap rather than a single-tap, the operating system can start up an Internet-browsing application process in a manner that causes the Internet-browsing application process to request (over the wireless network interface) and present (on the display) a web page that is the same web page that the Internet-browsing application most recently displayed during its most recent previous use.

FIG. 5 is a flow diagram illustrating an example of a technique 500 whereby an operating system of a mobile device can execute an application process in a manner that causes the application process to select, for presentation, a particular user interface from a group of multiple user interfaces based on whether the operating system detected a single-tap or a double-tap relative to an icon to which the application pertains, according to an embodiment of the invention. For example, technique 500 can be performed by mobile device 200 of FIG. 2, or, more specifically, by an operating system executing on mobile device 200 in conjunction with hardware components that detect touchscreen contact and send signals to that operating system. Although certain operations are described as being performed in a certain order in technique 500, alternative embodiments of the invention can involve similar techniques being performed with fewer, additional, or different operations, and/or with those operations being performed in a different order.

In block 502, a mobile device can detect touchscreen interaction by a user relative to an application icon displayed on the device's touchscreen. For example, the mobile device can detect that a user has performed a single-tap or a double-tap relative to an icon that pertains to a currently non-executing application program.

In block 504, in response to detecting the touchscreen interaction in block 502, the mobile device can determine whether the interaction was a single-tap or a double-tap. If the interaction was a single-tap, then control passes to block 506. Alternatively, if the interaction was a double-tap, then control passes to block 508.

In block 506, the mobile device can execute an application process for an application corresponding to the icon in a manner that causes the application process to present, initially, a first user interface from a group of application user interfaces. For example, in response to determining that the interaction relative to an application's icon was a single-tap rather than a double-tap, the operating system can start up an application process in a manner that causes the application process to present, initially, a first set of user-selectable menu options.

Alternatively, In block 508, the mobile device can execute an application process for an application corresponding to the icon in a manner that causes the application process to present, initially, a second user interface from the group of application user interfaces. For example, in response to determining that the interaction relative to an application's icon was a double-tap rather than a single-tap, the operating system can start up an application process in a manner that causes the application process to present, initially, a second set of user-selectable menu options that differs from the first set of user-selectable menu options mentioned above in connection with block 506.

FIG. 6 is a flow diagram illustrating an example of a technique 600 whereby an operating system of a mobile device can execute an application process in a manner that causes the application process to begin executing at a point in its code that is selected based on whether the operating system detected a single-tap or a double-tap relative to an icon to which the application pertains, according to an embodiment of the invention. For example, technique 600 can be performed by mobile device 200 of FIG. 2, or, more specifically, by an operating system executing on mobile device 200 in conjunction with hardware components that detect touchscreen contact and send signals to that operating system. Although certain operations are described as being performed in a certain order in technique 600, alternative embodiments of the invention can involve similar techniques being performed with fewer, additional, or different operations, and/or with those operations being performed in a different order.

In block 602, a mobile device can detect touchscreen interaction by a user relative to an application icon displayed on the device's touchscreen. For example, the mobile device can detect that a user has performed a single-tap or a double-tap relative to an icon that pertains to a currently non-executing application program.

In block 604, in response to detecting the touchscreen interaction in block 602, the mobile device can determine whether the interaction was a single-tap or a double-tap. If the interaction was a single-tap, then control passes to block 606. Alternatively, if the interaction was a double-tap, then control passes to block 608.

In block 606, the mobile device can execute an application process for an application corresponding to the icon beginning at a first point within the application's executable code. For example, in response to determining that the interaction relative to an application's icon was a single-tap rather than a double-tap, the operating system can start up an application process by executing the application beginning at a first point in the application's executable code that comes before or after a second point in the application's executable code. If the first point comes before the second point, then the application can reach the second point subsequently during execution.

Alternatively, block 608, the mobile device can execute an application process for an application corresponding to the icon beginning at a second point within the application's executable code. For example, in response to determining that the interaction relative to an application's icon was a double-tap rather than a single-tap, the operating system can start up an application process by executing the application beginning at the second point in the application's executable code that comes before or after the first point in the application's executable code mentioned above in connection with block 606. If the second point comes before the second point, then the application can reach the first point subsequently during execution.

FIG. 7 is a flow diagram illustrating an example of a technique 700 whereby an operating system of a mobile device can either context-switch to an application process or terminate that application process depending on whether the operating system detected a single-tap or a double-tap relative to an icon to which the application process pertains, according to an embodiment of the invention. A mobile device potentially can multi-task by concurrently executing multiple application processes. In an embodiment, only one of these application processes is active at a particular time, and the states of the other inactive application processes are stored in memory until they are selected for activation, at which time the previously active application process's state is stored in memory. For example, technique 700 can be performed by mobile device 200 of FIG. 2, or, more specifically, by an operating system executing on mobile device 200 in conjunction with hardware components that detect touchscreen contact and send signals to that operating system. Although certain operations are described as being performed in a certain order in technique 700, alternative embodiments of the invention can involve similar techniques being performed with fewer, additional, or different operations, and/or with those operations being performed in a different order.

In block 702, a mobile device can detect touchscreen interaction by a user relative to an application icon displayed on the device's touchscreen. For example, the mobile device can detect that a user has performed a single-tap or a double-tap relative to an icon that pertains to a currently executing application process.

In block 704, in response to detecting the touchscreen interaction in block 702, the mobile device can determine whether the interaction was a single-tap or a double-tap. If the interaction was a single-tap, then control passes to block 706. Alternatively, if the interaction was a double-tap, then control passes to block 708.

In block 706, the mobile device can perform a context-switch so that the in-memory state of the application process corresponding to the icon is used to resume execution of the application process, thereby making that application process the active process. For example, in response to determining that the interaction relative to an application process's icon was a single-tap rather than a double-tap, the operating system can activate the application process by performing a context-switch that causes the execution of the application to resume using its stored state in memory.

Alternatively, block 708, the mobile device can terminate an application process corresponding to the icon. For example, in response to determining that the interaction relative to an application's icon was a double-tap rather than a single-tap, the operating system can terminate execution of the application process if it is currently active, and free the memory that is allocated to the storage of that application process's state. This can cause the application process's icon to vanish from the set of icons for currently executing application processes.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above can make reference to specific hardware and software components, those skilled in the art will appreciate that different combinations of hardware and/or software components can also be used and that particular operations described as being implemented in hardware might also be implemented in software or vice versa.

Computer programs incorporating various features of the present invention can be encoded and stored on various computer readable storage media; suitable media include magnetic disk or tape, optical storage media such as compact disk (CD) or DVD (digital versatile disk), flash memory, and other non-transitory media. Computer readable media encoded with the program code can be packaged with a compatible electronic device, or the program code can be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method comprising:
receiving, through a touch screen, first user input indicating a double tap relative to an application; and
in response to receiving the first user input, an operating system sending, to the application, a first signal that is different from a second signal that the operating system sends to the application in response to receiving second user input indicating a single tap relative to the application.

2. The method of claim 1, wherein receiving the first user input indicating the double tap comprises detecting a second tap relative to the application within a specified threshold amount of time of detecting a first tap relative to the application.

3. The method of claim 1, wherein sending the first signal to the application comprises invoking a first method of the application that differs from a second method that the operating system invokes to send the second signal to the application.

4. The method of claim 1, wherein the first signal causes a process for the application to become a currently active process within a set of concurrently executing application processes; and wherein the second signal causes a process for the application to terminate.

5. The method of claim 1, wherein the first signal causes a process for the application to present content previously generated using the application; and wherein the second signal causes a process for the application to present a user interface through which a user can user generate new content using the application.

6. The method of claim 1, wherein the first signal causes the application to present, initially, a home page having a uniform resource location specified in configuration settings for the application; and wherein the second signal causes the application to present, initially, a web page that the application most recently presented during a most recent previous execution of the application.

7. The method of claim 1, wherein the first signal causes the application to present, initially, a list of stored messages; and wherein the second signal causes the application to present, initially, a user interface through which a new message can be composed.

8. The method of claim 1, wherein the first signal causes the application to begin executing at a first point in executable code that is before a second point in the executable code; and wherein the second signal causes the application to begin executing at the second point in the executable code.

9. The method of claim 1, wherein the first signal causes the application to begin executing at a first point in executable code that is after a second point in the executable code; and wherein the second signal causes the application to begin executing at the second point in the executable code.

10. The method of claim 1, wherein the first signal causes the application to present, initially, a first application user interface that includes a first set of user-selectable options; and wherein the second signal causes the application to present, initially, a second application user interface that includes a second set of user-selectable options that differs from the first set.

11. A computer-readable memory comprising particular instructions that are executable by one or more processors to cause the one or more processors to perform operations, the particular instructions comprising:
instructions to cause an operating system of a mobile device to detect one user tap on a displayed object during a first specified time interval;
instructions to cause the operating system to invoke, in response to detecting the one user tap on the displayed object, a program with a first set of parameters that cause the program to display a first user interface;
instructions to cause the operating system to detect, during a second specified time interval, multiple user taps on the displayed object; and
instructions to cause the operating system to invoke, in response to detecting the multiple user taps on the displayed object, the program with a second set of parameters that cause the program to display a second user interface that differs from the first user interface.

12. The computer-readable memory of claim 11, wherein the particular instructions further comprise instructions to cause the operating system to display a plurality of objects including the displayed object, each object of the plurality of objects corresponding to a separate program that is accessible through interaction with the operating system.

13. The computer-readable memory of claim 11, wherein the first user interface includes a first set of user-selectable menu options; and wherein the second user interface includes a second set of user-selectable menu options that differs from the first set.

14. The computer-readable memory of claim 11, wherein the first user interface contains a set of items previously created using the program; and wherein the second user interface enables a user to create a new item using the program.

15. A computer-readable memory comprising particular instructions that are executable by one or more processors to cause the one or more processors to perform operations, the particular instructions comprising:
instructions to cause a computing device to detect a first gesture relative to a first icon that represents a first process executing on the computing device;
instructions to cause the computing device to determine that the first gesture is a double-tap; and
instructions to cause the computing device to terminate execution of the first process in response to determining that the gesture is a double-tap.

16. The computer-readable memory of claim 15, wherein the particular instructions further comprise:
instructions to cause the computing device to detect a second gesture relative to a second icon that represents a second process executing on the computing device;
instructions to cause the computing device to determine that the second gesture is a single-tap; and
instructions to cause the computing device to perform a context-switch to the second process in response to determining that the gesture is a double-tap.

17. The computer-readable memory of claim 15, wherein the instructions to cause the computing device to terminate execution of the first process in response to determining that the gesture is a double-tap comprise instructions to cause an operating system executing on the computing device to send, to the first process, a double-tap signal that differs from a single-tap signal.

18. The computer-readable memory of claim 15, wherein the instructions to cause the computing device to terminate execution of the first process in response to determining that the gesture is a double-tap comprise instructions to cause an operating system executing on the computing device to invoke a double-tap method whose interface is standardized among each program of a plurality of programs on the computing device but which is implemented differently by each program of the plurality of programs stored on the computing device.

19. The computer-readable memory of claim 15, wherein the particular instructions further comprise:
instructions to cause the computing device to register, with an operating system executing on the computing device, an interest by the first process in events that are of a double-tap event type;
instructions to cause the computing device to generate a particular event of the double-tap event type in response to determining that the first gesture is a double-tap; and
instructions to cause the computing device to alert the first process to an occurrence of the particular event based on the registration by the first process with the operating system.

20. A computer-readable memory comprising particular instructions that are executable by one or more processors to cause the one or more processors to perform operations, the particular instructions comprising:
instructions to cause an operating system of a device to detect a quantity of taps against a surface during a specified time interval; and
instructions to cause the operating system, in response to detecting the quantity of taps during the specified time interval, to cause an application to behave with a behavior that is mapped to the quantity of taps.

21. The computer-readable memory of claim 20, wherein a single-tap is mapped to a first behavior, and wherein a double-tap is mapped to a second behavior that differs from the first behavior.

23. The computer-readable memory of claim 20, wherein the instructions to cause the operating system to cause the application to behave with the behavior that is mapped to the quantity of taps comprise instructions to cause the application to begin executing at a first point in executable code of the application in response to the quantity of taps being a first quantity; wherein the instructions to cause the operating system to cause the application to behave with the behavior that is mapped to the quantity of taps comprise instructions to cause the application to begin executing at a second point in the executable code of the application in response to the quantity of taps being a second quantity; wherein the first quantity differs from the second quantity; and wherein the first point comes before the second point in the executable code of the application.

23. The computer-readable memory of claim 20, wherein the instructions to cause the operating system to cause the application to behave with the behavior that is mapped to the quantity of taps comprise instructions to cause the application to begin executing at a first point in executable code of the application in response to the quantity of taps being a first quantity; wherein the instructions to cause the operating system to cause the application to behave with the behavior that is mapped to the quantity of taps comprise instructions to cause the application to begin executing at a second point in the executable code of the application in response to the quantity of taps being a second quantity; wherein the first quantity differs from the second quantity; and wherein the first point comes before the second point in the executable code of the application.

24. A mobile device comprising:
means for detecting a user gesture relative to a touchscreen of a mobile device;
means for determining whether the gesture is a single-tap or a double-tap; and
means for causing an operating system of the mobile device to send, to an application accessible through the operating system, a signal having a type that is selected based on whether the gesture is a single-tap or a double-tap.

25. The mobile device of claim 24, further comprising:
means for causing the application to load and present a user interface through which a user can create a new content item in response to detection that the gesture is a double-tap; and
means for causing the application to load and present a list of content items previously stored by the application in response to detection that the gesture is a single-tap.
